(19) United States
(12) Patent Application Publication
(10) Pub. No.: US 2024/0307842 A1
(43) Pub. Date: Sep. 19, 2024

(54) FLOW REACTOR SYSTEM AND FLOW REACTION METHOD

(71) Applicant: AGENCY FOR SCIENCE, TECHNOLOGY AND RESEARCH, Singapore (SG)

(72) Inventors: Yee Fun LIM, Singapore (SG); Yang XU, Singapore (SG); Jian Wei Jayce CHENG, Singapore (SG); Swee Liang WONG, Singapore (SG); Vijila CHELLAPPAN, Singapore (SG); Jatin KUMAR, Singapore (SG); Daniil BASH, Singapore (SG); Tonio BUONASSISI, Singapore (SG); Kedar HIPPALGAONKAR, Singapore (SG)

(21) Appl. No.: 18/576,009

(22) PCT Filed: Jul. 20, 2022
(86) PCT No.: PCT/SG2022/050514

§ 371 Date: Jan. 2, 2024

(30) Foreign Application Priority Data
Jul. 22, 2021 (SG) 10202107985P

(51) Int. Cl. B01J 19/00; B01J 4/00; B01J 14/00; B01J 19/24; B29C 64/314; B29C 64/393; B33Y 40/00; B33Y 50/02

(52) U.S. Cl. CPC B01J 19/0033; B01J 4/008; B01J 14/00; B01J 19/24; B29C 64/314; B29C 64/393; B33Y 40/00; B33Y 50/02; B01J 2204/002; B01J 2219/00164; B01J 2219/00202; B01J 2219/00243

(57) ABSTRACT

The present disclosure generally relates to a flow reactor system (100) and a flow reaction method (200). The flow reactor system (100) comprises liquid pumps (110) for communicating liquid reagents based on a set of flow conditions, a fluid pump (200) for communicating a carrier fluid that is immiscible with the liquid reagents; a fluidic mixer (130) for mixing the liquid reagents into a liquid mixture, a measurement device (150) for measuring properties of liquid plugs (140) discharged from an outlet (136) of the fluidic mixer (130); and a control module configured for controlling the liquid pumps (110) and adjusting the flow conditions based on the measured properties of the liquid plugs (140), wherein the liquid plugs (140) are representative of different flow conditions.

### CROSS REFERENCE TO RELATED APPLICATION(S)

The present disclosure claims the benefit of Singapore Patent Application No. 10202107985P filed on 22 Jul. 2021, which is incorporated in its entirety by reference herein.

### TECHNICAL FIELD

The present disclosure relates to a flow reactor system and a flow reaction method.

### BACKGROUND

Designing new materials with desired output characteristics or properties involves multiple stages of materials and process development cycles. For example, flow reactor systems work on the principle of flow chemistry to synthesise new materials. Flow chemistry is a well-established technique wherein streams of fluids are continuously flowed, and if the fluids are reactive, a chemical reaction takes place and a new compound is formed. However, currently available flow reactor systems focus mainly on synthesising new materials, and the characterization of the new materials is done separately. The current approach of synthesising and characterising new materials is tedious and ineffective and has low throughput.

Therefore, in order to address or alleviate at least one of the aforementioned problems and/or disadvantages, there is a need to provide an improved flow reactor system and flow reaction method.

### SUMMARY

According to a first aspect of the present disclosure, there is a flow reactor system comprising:
a plurality of liquid pumps for communicating a plurality of liquid reagents based on a set of flow conditions;
a fluid pump for communicating a carrier fluid that is immiscible with the liquid reagents;
a fluidic mixer for mixing the liquid reagents into a liquid mixture, the fluidic mixer comprising:
   a plurality of liquid inlets for receiving the liquid reagents from the liquid pumps;
   a fluid inlet for receiving the carrier fluid from the fluid pump; and
   an outlet for discharging the liquid mixture and the carrier fluid, wherein the liquid mixture is discharged from the outlet as a series of liquid plugs separated by the carrier fluid;
a measurement device for measuring properties of the liquid plugs discharged from the outlet; and
a control module configured for controlling the liquid pumps and adjusting the flow conditions based on the measured properties of the liquid plugs, wherein the liquid plugs are representative of different flow conditions.

According to a second aspect of the present disclosure, there is a flow reaction method comprising:
communicating a plurality of liquid reagents from a plurality of liquid pumps to a fluidic mixer based on a set of flow conditions;
communicating a carrier fluid from a fluidic pump to the fluidic mixer, the carrier fluid being immiscible with the liquid reagents;
mixing the liquid reagents into a liquid mixture in the fluidic mixer;
discharging the liquid mixture and the carrier fluid from the fluidic mixer, the liquid mixture being discharged as a series of liquid plugs separated by the carrier fluid;
measuring properties of the liquid plugs discharged from the fluidic mixer; and
controlling the liquid pumps and adjusting the flow conditions based on the measured properties of the liquid plugs, wherein the liquid plugs are representative of different flow conditions.

A flow reactor system and a flow reaction method according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of a flow reactor system according to embodiments of the present disclosure.

FIG. 2 is an illustration of a fluidic mixer of the flow reactor system.

FIG. 3 is an illustration of fluidic tubings connected to the fluidic mixer.

FIG. 4 is an illustration of a measurement device of the flow reactor system.

FIGS. 5A to 5D are illustrations of measurements by the measurement device.

FIGS. 6A and 6B are illustrations of a 3D printing machine cooperative with the flow reactor system.

FIG. 7 is a flowchart illustration of a flow reaction method according to embodiments of the present disclosure.

### DETAILED DESCRIPTION

For purposes of brevity and clarity, descriptions of embodiments of the present disclosure are directed to a flow reactor system and a flow reaction method, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith. References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment. As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The terms “first”, “second”, etc. are used merely as labels or identifiers and are not intended to impose numerical requirements on their associated terms.

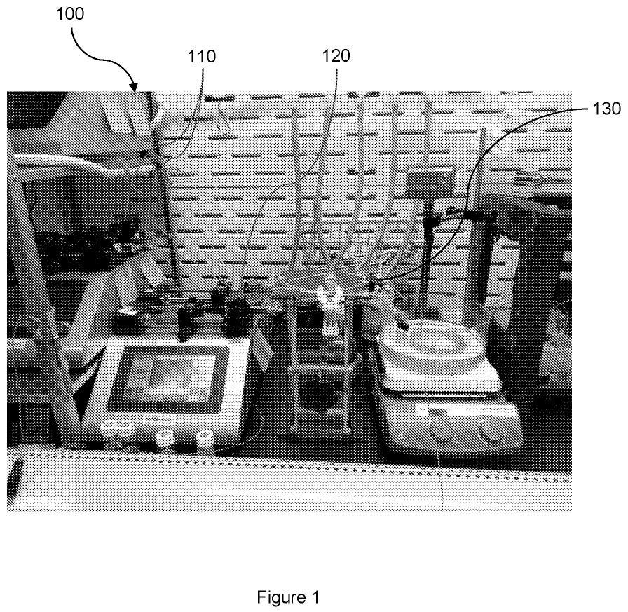

A flow reactor system 100 is described in representative or exemplary embodiments of the present disclosure, as shown in FIG. 1. The flow reactor system 100 includes a plurality of liquid pumps 110 for communicating a plurality of liquid reagents based on a set of flow conditions. For example, the liquid pumps 110 include syringe pumps. The flow reactor system 100 includes a fluid pump 120 for communicating a carrier fluid that is immiscible with the liquid reagents. For example, the carrier fluid is a liquid or a gas, preferably an inert gas such as nitrogen or argon.

The flow reactor system 100 includes a fluidic mixer 130 for receiving the liquid reagents from the liquid pumps 110 and the carrier fluid from the fluid pump 120, and for mixing the liquid reagents into a liquid mixture. The fluidic mixer 130 is a fluidic device that has channels for receiving and mixing fluids together such that they can undergo a chemical reaction therein. Preferably, the fluidic mixer 130 is a microfluidic one such that fluids flow through microfluidic channels typically of the micrometre dimensional scale. For example, the fluidic mixer 130 includes coiled microchannels. The fluidic mixer 130 may include a T-junction, cross-junction, or multi-port manifold.

The flow reactor system 100 includes a control module configured for controlling the liquid pumps 110 and adjusting the flow conditions. The flow conditions may include volume and flow rate of the liquid reagents. More specifically, the flow conditions may include the volume and flow rate of each liquid reagent at each step, as well as the time taken for each step. For example, a liquid pump 110 is controlled to supply the liquid reagent one step at a time at the specified volume for each step. The control module automates operation of the liquid pumps 110 such that the liquid reagents are automatically delivered to the fluidic mixer 130 according to the flow conditions. A program, such as LabVIEW, may be executed on the control module to control the liquid pumps 110. The flow conditions may be defined in a recipe file that can be loaded by the program. The program may also indicate the minimum and maximum flow rate limits of each liquid pump 110, so that the flow conditions are maintained within these limits. Once the program is executed, the liquid pumps 110 will start to run automatically and deliver the liquid reagents to the fluidic mixer 130, and the status of each liquid pump 110 can be shown at each step.

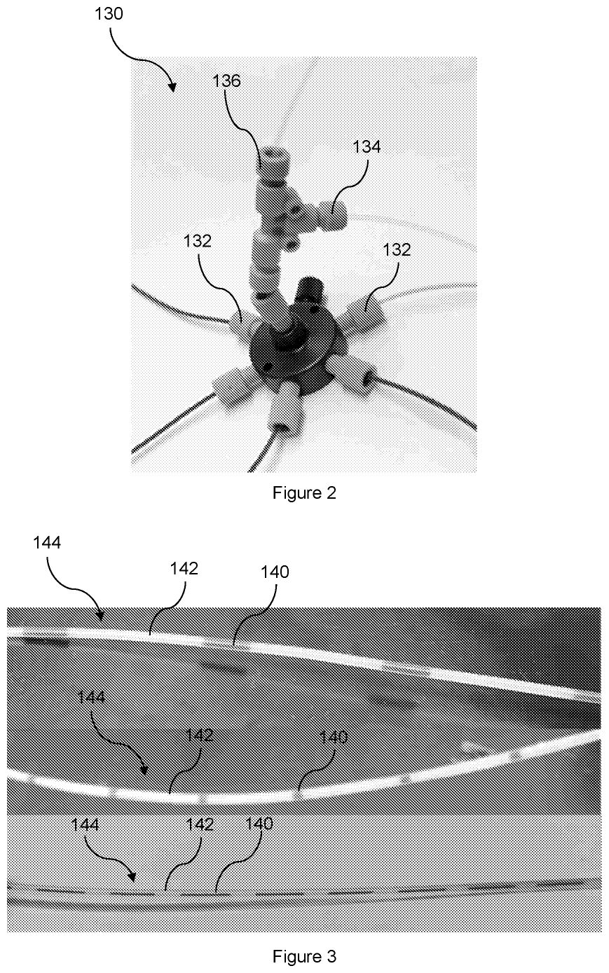

Further as shown in FIG. 2, the fluidic mixer 130 includes a plurality of liquid inlets 132 for receiving the liquid reagents from the liquid pumps 110. For example, each liquid inlet 132 receives a respective liquid reagent from a respective liquid pump 110. The fluidic mixer 130 may include one or more microfluidic channels or chambers for mixing the liquid reagents into the liquid mixture. For example, the liquid reagents flowing into the liquid inlets 132 undergo a chemical reaction in the fluidic mixer 130 and form a new product that is the liquid mixture. The liquid reagents entering the fluidic mixer 130 are mixed in the desired ratios according to the flow conditions. The fluidic mixer 130 includes a fluid inlet 134 for receiving the carrier fluid from the fluid pump 120. The fluidic mixer 130 includes an outlet 136 for discharging the liquid mixture and the carrier fluid.

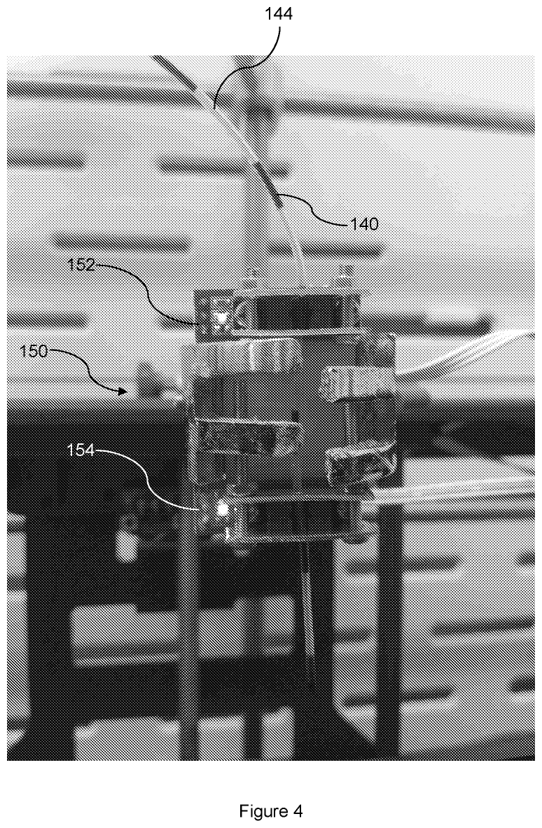

More specifically, the liquid mixture is discharged from the outlet 136 as a series of liquid plugs 140 separated by the carrier fluid. As the carrier fluid is immiscible with the liquid reagents, the liquid plugs 140 (which are formed from the liquid reagents) do not mix with the carrier fluid and the liquid plugs 140 can be spaced apart from each other by gaps 142 formed by the carrier fluid. The size of the liquid plugs 140 and the separation between the liquid plugs 140 can be controlled by the flow conditions of the liquid reagents, flow rates of the liquid mixture and carrier fluid, and the dimensions of the fluidic mixer 130, such as the diameters of microchannels in the fluidic mixer 130. Various examples of the liquid plugs 140 discharged from the outlet 136 along a fluidic tubing 144 connected to the outlet 136 are shown in FIG. 3. Among these examples, the liquid plugs 140 have different sizes and separation distances, and in each example, the liquid plugs 140 are identically sized and uniformly separated by the carrier fluid gaps 142.

In some embodiments, the flow reactor system 100 includes a mass flow controller for controlling the fluid pump 120 to provide a stable supply of the carrier fluid to the fluidic mixer 130. Preferably, the fluid pump 120 delivers the carrier fluid at a slow flow rate to accommodate further processing of the liquid plugs 140, such as for dispensing and to measure their properties or characteristics as described below. For example, the mass flow controller controls the fluid pump 120 to deliver the carrier fluid at up to 5 sccm (standard cubic centimetres per minute). The mass flow controller is configured to automatically compensate for fluid pressure changes to maintain stable flow of the carrier fluid and consistent carrier fluid gaps 142 between the liquid plugs 140.

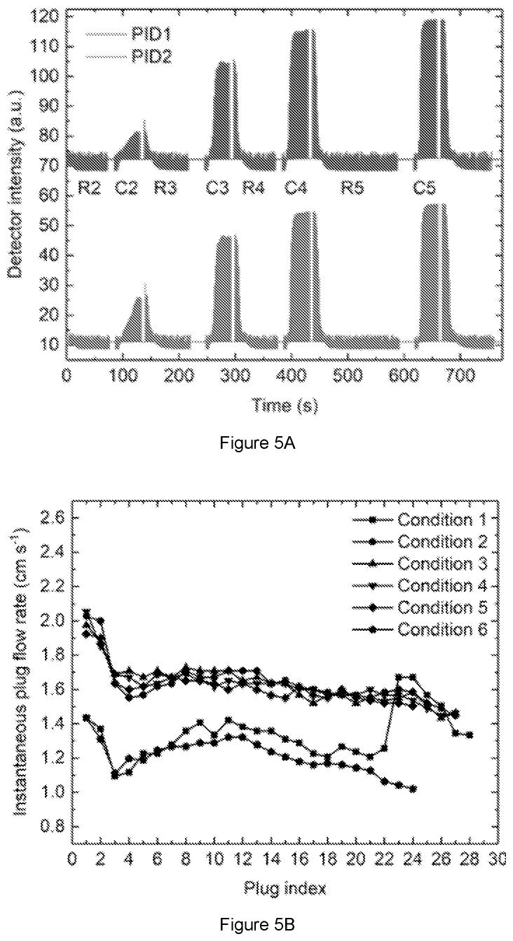

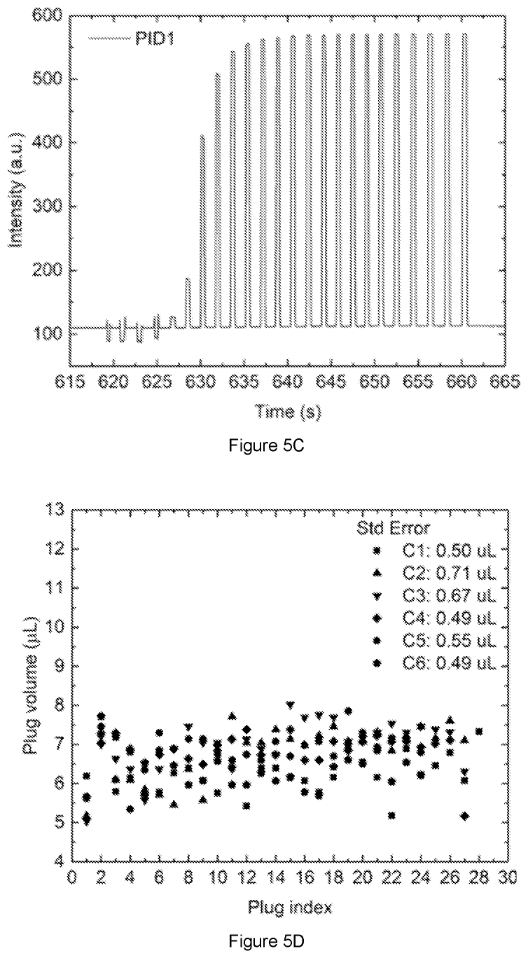

The flow reactor system 100 further includes a measurement device 150 for measuring properties of the liquid plugs 140 discharged from the outlet 136. The properties may include flow rate, volume, and intensity of the liquid plugs. For example, the measurement device 150 is coupled to the fluidic tubing 144 connected to the outlet 136. In some embodiments as shown in FIG. 4, the measurement device 150 includes a first photodetector 152 and a second photodetector 154 at a fixed distance from each other. The photodetectors 152,154 may include infrared photointerrupters configured for measuring the flow rate, volume, and intensity of the liquid plugs 140. For example, the infrared photointerrupters are TCST2103 photointerrupters with a wavelength of around 950 nm. The composition of the liquid plugs 140 may also be obtained if there is significant absorption at the 950 nm wavelength. However, even if there is poor absorption, the photodetectors 152,154 may still be able to differentiate between an empty fluidic tubing 144 and one with the liquid plugs 140 due to scattering from the liquid plugs 140. Various measurements from the photodetectors 152,154 are shown in FIGS. 5A to 5D for liquid plugs 140 formed of a composite of carbon nanotubes (CNT) and poly(3-hexylthiophene) (P3HT).

When the optical path of each infrared photodetector 152,154 is interrupted by a liquid plug 140 passing through the fluidic tubing 144, the photodetector output signal can decrease if the liquid plug 140 absorbs infrared radiation and increase if the liquid plug 140 scatters infrared radiation. As the liquid plugs 140 flow through the fluidic tubing 144, the output signals from the photodetectors 152,154 display a time lag as shown in FIG. 5A. The time lag can be used to derive the speed at which the liquid plugs 140 are flowing through the fluidic tubing 144, which can then be used to manipulate the positioning of the liquid plugs 140 when they are dispensed from the fluidic tubing 144. FIG. 5A shows how the intensity of the output signals varies for different compositions of the liquid plugs 140. Particularly, C2 to C5 represent four different CNT/P3HT compositions of the liquid plugs 140 obtained from different flow conditions. R2 to R5 are rinsing cycles using liquid plugs 140 consisting of a neat rinse solvent. The rinse solvent may include chlorobenzene, dichlorobenzene, or chloroform. The rinse solvent liquid plugs 140 are flowed through the fluidic tubing 144 after each batch of CNT/P3HT liquid plugs 140 to rinse away any remaining formulation before the next batch of CNT/P3HT liquid plugs 140 is released to the fluidic tubing 144. As the various liquid plugs 140 flow through the fluidic tubing 144, the photodetectors 152,154 detect the CNT/P3HT liquid plugs 140 (with positive intensity) and rinsing liquid plugs 140 (with negative intensity).

FIG. 5B shows the speed or flow rate of the liquid plugs 140 for six different flow conditions. The plug index refers to the sequence of liquid plugs 140 flowing through the fluidic tubing 144. Notably, there is variation in the flow rate due to pressure regulation from the fluid pump 120. Measuring the flow rate of the liquid plugs 140 in real time can facilitate accurate dispensation of the liquid plugs 140.

As shown in FIG. 5C, the photodetectors 152,154 measure the intensity of the liquid plugs 140 obtained from a single flow condition (C5 from FIG. 5A). Positive intensities relate to concentrations of CNT in the liquid plugs 140, negative intensities relate to the measurements of the carrier fluid, and zero intensities represent the baseline measurement of an empty fluidic tubing 144. Notably, the intensities stabilize after about 12 liquid plugs 140 due to residual rinse solvent in the fluidic tubing 144.

This means that the first 12 liquid plugs 140 should be discarded. The intensities can be used for process control for determining the liquid plugs 140 that has stabilized into a steady state.

In one example as shown in FIG. 5D, the photodetectors 152,154 measure the length of the liquid plugs 140 which can be converted to plug volume by the internal diameter of the fluidic tubing 144. The calculated volumes of the liquid plugs 140 have an error is less than 1 μL, which is excellent for microfluidic batch control.

In some embodiments, the measurement device 150 may include other instruments such as a hyperspectral camera, a Fourier-transform infrared spectroscopy (FTIR) spectrometer, and/or a Raman spectrometer.

The control module is further configured for adjusting the flow conditions based on the measured properties of the liquid plugs 140, wherein the liquid plugs 140 are representative of different flow conditions. For example, the control module iteratively adjusts the flow conditions to optimize one or more pre-selected properties of the liquid plugs 140, such as the CNT concentration.

In some embodiments, the control module is configured for training a machine learning model using training data derived from the measured properties. Training data from the properties measured by the measurement device 150 are stored in a training database and fed to the machine learning model which can be used to correlate the measured properties with the flow conditions. These property correlations can be used to establish a feedback control loop for automated adjustment of the flow conditions, such as to optimize one or more properties of the liquid plugs 140. These properties may include, but are not limited to, absorption intensity as measured by the photodetectors 152,154, and sheet resistance of thin films formed by the liquid plugs 140,

As an example, the measured properties from a first set of flow conditions are fed as training data to the machine learning model. The machine learning model then generates a second set of flow conditions based on the training data. The second set of flow conditions are defined in a new recipe file that is then loaded by the LabVIEW program. The control module executes the program with the new recipe file and the liquid pumps 110 deliver the liquid reagents to the fluidic mixer 130 based on the second set of flow conditions. The machine learning process repeats in a self-driven control loop and the machine learning model iteratively generates new sets of flow conditions.

In some embodiments, the flow conditions are iteratively generated to optimize the chemical reaction between the liquid reagents that form the liquid mixture, and/or until the desired outcome or targeted property is achieved. For example, the machine learning process aims to optimize one or more pre-selected properties of the liquid plugs 140, such as the CNT concentration and electrical resistance. Each liquid plug 140 is thus representative of a unique set of flow conditions and the liquid plugs 140 may be identified with the respective flow conditions based on the time stamps associated with the steps of the flow conditions.

The machine learning model may be trained using various suitable machine learning or artificial intelligence algorithms, such as but not limited to, a Bayesian optimization algorithm (or its variants). It will be appreciated that the machine learning model is not limited to any software platform or programming language, and the machine learning model may be executed using any number of known platforms and/or languages. Some other non-limiting examples include reinforcement learning algorithms, regression algorithms, and neural networks.

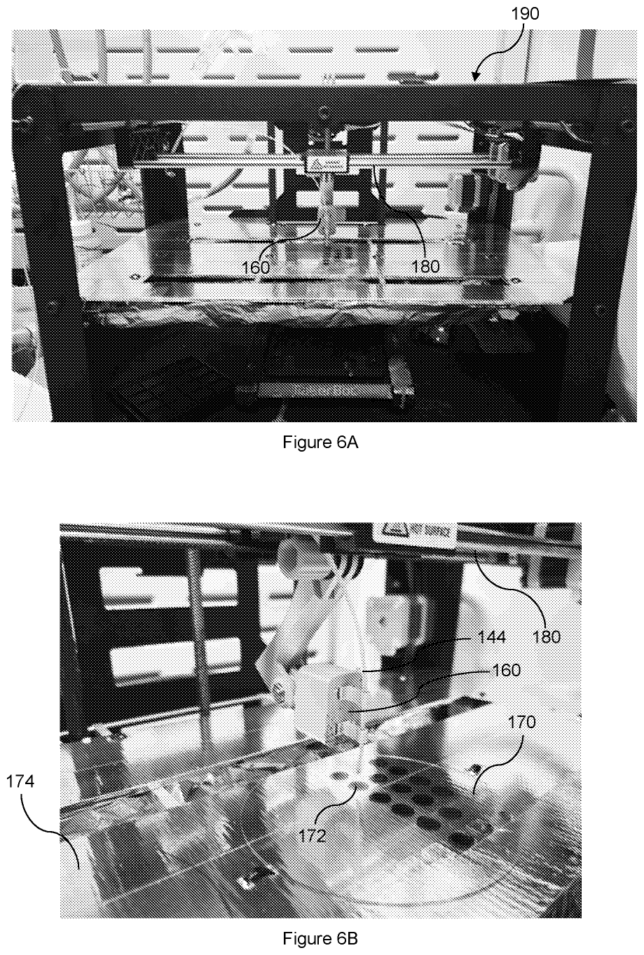

In some embodiments as shown in FIGS. 6A and 6B, the flow reactor system 100 includes a tube holder 160 for facilitating dispensation of the liquid plugs 140 discharged from the fluidic mixer 130. For example, the tube holder 160 is coupled to the other end of the fluidic tubing 144 connected to the outlet 136 of the fluidic mixer 130. A liquid plug 140 may be dispensed by drop casting onto a substrate 170 and the drop casted liquid plug 140 forms a thin film 172 on the substrate 170. Further measurements may be performed on the thin film 172, such as to characterise its optical and electrical properties.

In some embodiments, the flow reactor system 100 includes an actuation assembly 180 for dispensing the liquid plugs 140 over an area, such as on one or more substrates 170. In one embodiment, the tube holder 160 is coupled to the actuation assembly 180 such that the tube holder 160 is moveable horizontally (i.e. along a horizontal or XY plane) and optionally vertically along the Z axis. In another embodiment, the actuation assembly 180 is coupled to a platform 174 supporting a substrate 170 for moving the substrate 170 horizontally and optionally vertically. In another embodiment, the actuation assembly 180 is coupled to the tube holder 160 and the platform 174 for moving the tube holder 160 and substrate 170 horizontally and optionally vertically. The horizontal motion of the tube holder 160 and/or substrate 170 enables the liquid plugs 140 to be drop casted as an array of thin films 172 on the substrate 170.

In some embodiments, there is a 3D printing machine 190 cooperative with the flow reactor system 100. More specifically, the tube holder 160 and actuation assembly 180 are integrated in the 3D printing machine 190. The actuation assembly 180 includes a moving track 172 of the 3D printing machine 190 and the tube holder 160 is mounted on the moving track 172 for horizontal motion along the XY plane. As an example, the actuation assembly 180 is configured to move the tube holder 160 at steps of 50 microns along the X and Y axes. In this configuration, an array of about 288 thin films 172 can be drop casted on the substrate 170 within about 1 hour. This is a high throughput generation of drop casted thin films 172 that are not wasted as would be the case in conventional microfluidic reactors. For example, the thin films 172 may be subjected to further post treatment as well as measurements to characterize them. Further, measured properties of the thin films 172, such as their sheet resistance, may be stored in the training database to train the machine learning model. The sheet resistance of the thin films 172 can be measured by a separate measurement device, for example one comprising a 4-point probe.

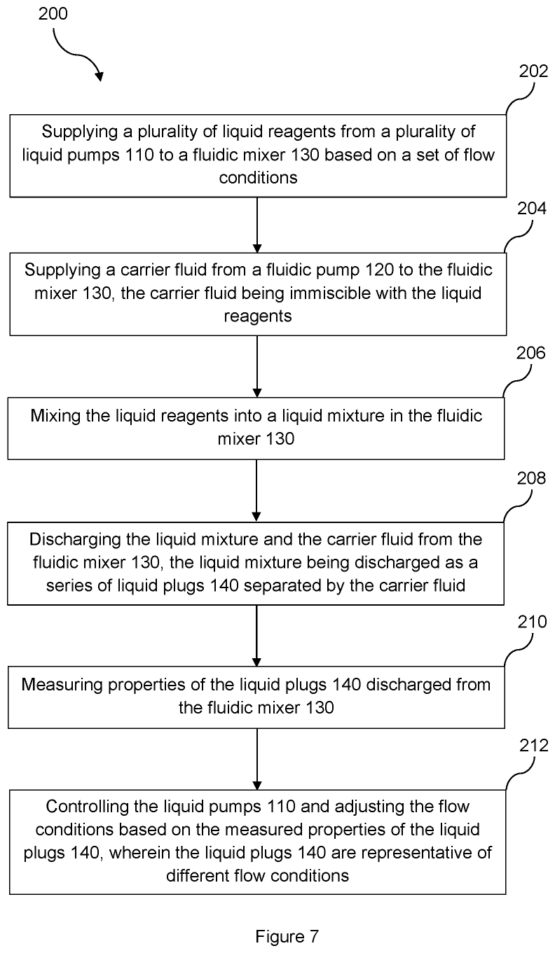

A flow reaction method 200 is described in representative or exemplary embodiments of the present disclosure, as shown in FIG. 7. For example, the method 200 may be performed using the flow reactor system 100 described herein. The method 200 includes a step 202 of communicating a plurality of liquid reagents from a plurality of liquid pumps 110 to a fluidic mixer 130 based on a set of flow conditions. The method 200 includes a step 204 of communicating a carrier fluid from a fluidic pump 120 to the fluidic mixer 130, the carrier fluid being immiscible with the liquid reagents. The method 200 includes a step 206 of mixing the liquid reagents into a liquid mixture in the fluidic mixer 130. The method 200 includes a step 208 of discharging the liquid mixture and the carrier fluid from the fluidic mixer 130, the liquid mixture being discharged as a series of liquid plugs 140 separated by the carrier fluid. The method 200 includes a step 210 of measuring properties of the liquid plugs 140 discharged from the fluidic mixer 130. The method 200 includes a step 212 of controlling the liquid pumps 110 and adjusting the flow conditions based on the measured properties of the liquid plugs 140, wherein the liquid plugs 140 are representative of different flow conditions.

The flow reactor system 100 and flow reaction method 200 provide a reaction/formulation platform with high throughput generation of liquid plugs 140 and thin films 172 that can exceed 200 samples per hour. Desired compositions of liquid reagents in the liquid plugs 140 can be obtained via automated control of the liquid pumps 110 supplying the liquid reagents and their flow conditions, resulting in multiple unique reactions generated within minutes. Moreover, a uniform circulating flow profile develops inside each liquid plug 140 when the liquid reagents are mixed in the fluidic mixer 130, providing for enhanced mixing of the liquid reagents.

The flow reactor system 100 and flow reaction method 200 also utilize a machine learning model to automatically determine flow conditions that optimize the reactions based on measured properties of the liquid plugs 140. The characterisation of the liquid plugs 140 by the measurement device 150 is integrated with the reaction platform to quickly eliminate unsuitable flow conditions and more efficiently optimize the flow conditions. The machine learning model can reduce the time in research and development of new materials and accelerate the discovery of new materials. Some applications accelerating discovery of new materials include semiconductor thin films, polymer synthesis, and flow catalysis.

In the foregoing detailed description, embodiments of the present disclosure in relation to a flow reactor system and a flow reaction method are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A flow reactor system comprising:
a plurality of liquid pumps for communicating a plurality of liquid reagents based on a set of flow conditions;
a fluid pump for communicating a carrier fluid that is immiscible with the liquid reagents;
a fluidic mixer for mixing the liquid reagents into a liquid mixture, the fluidic mixer comprising:
a plurality of liquid inlets for receiving the liquid reagents from the liquid pumps;
a fluid inlet for receiving the carrier fluid from the fluid pump; and
an outlet for discharging the liquid mixture and the carrier fluid, wherein the liquid mixture is discharged from the outlet as a series of liquid plugs separated by the carrier fluid;
a measurement device for measuring properties of the liquid plugs discharged from the outlet; and
a control module configured for controlling the liquid pumps and adjusting the flow conditions based on the measured properties of the liquid plugs, wherein the liquid plugs are representative of different flow conditions.

2. The system according to claim 1, wherein the flow conditions comprise volume and flow rate of the liquid reagents.

3. The system according to claim 1, further comprising a mass flow controller for controlling the fluid pump.

4. The system according to claim 3, wherein the mass flow controller is configured to control the fluid pump to communicate the carrier fluid at up to 5 sccm.

5. The system according to claim 3, wherein the mass flow controller is configured to automatically compensate for fluid pressure changes.

6. The system according to claim 1, wherein the properties comprise flow rate, volume, and intensity of the liquid plugs.

7. The system according to claim 1, wherein the measurement device comprises a first photodetector and a second photodetector at a fixed distance from each other.

8. The system according to claim 7, wherein the photodetectors comprise infrared photointerrupters.

9. The system according to claim 1, wherein the control module is configured for training a machine learning model using training data derived from the measured properties.

10. The system according to claim 9, wherein the machine learning model is trained to iteratively generate new sets of flow conditions.

11. The system according to claim 1, wherein a liquid plug is dispensable by drop casting as a thin film on a substrate.

12. The system according to claim 11, further comprising a tube holder for facilitating dispensation of the liquid plugs.

13. The system according to claim 12, further comprising an actuation assembly for dispensing the liquid plugs over an area.

14. The system according to claim 13, wherein the tube holder is coupled to the actuation assembly such that the tube holder is moveable horizontally.

15. The system according to claim 13, wherein the tube holder and actuation assembly are integrated in a 3D printing machine.

16. A flow reaction method comprising:
communicating a plurality of liquid reagents from a plurality of liquid pumps to a fluidic mixer based on a set of flow conditions;
communicating a carrier fluid from a fluidic pump to the fluidic mixer, the carrier fluid being immiscible with the liquid reagents;
mixing the liquid reagents into a liquid mixture in the fluidic mixer;
discharging the liquid mixture and the carrier fluid from the fluidic mixer, the liquid mixture being discharged as a series of liquid plugs separated by the carrier fluid;
measuring properties of the liquid plugs discharged from the fluidic mixer; and
controlling the liquid pumps and adjusting the flow conditions based on the measured properties of the liquid plugs, wherein the liquid plugs are representative of different flow conditions.

17. The method according to claim 16, further comprising training a machine learning model using training data derived from the measured properties.

18. The method according to claim 17, further comprising iteratively generating new sets of flow conditions using the trained machine learning model.

19. The method according to claim 16, further comprising drop casting a liquid plug as a thin film on a substrate.

20. The method according to claim 19, further comprising moving a tube holder horizontally to facilitate drop casting of the liquid plugs as an array of thin films on one or more substrates.
